(19) United States
(12) Patent Application Publication
(10) Pub. No.: US 2006/0293852 A1
(43) Pub. Date: Dec. 28, 2006

(54) Position detecting system and method

(75) Inventor: Kiyoshi Tsurumi, Obu-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/365,807

(22) Filed: Mar. 2, 2006

(30) Foreign Application Priority Data
Mar. 7, 2005 (JP) 2005-062800

(51) Int. Cl. G01C 21/00

(52) U.S. Cl. 701/216

(57) ABSTRACT

In a position detecting system by use of GPS signals, a navigation information retrieving part retrieves reception strength information outputted from a navigation device when a current position of a mobile body is in a region in which a multipath is liable to occur. A reception sensitivity change part changes, based on the reception strength information retrieved by the navigation information retrieving part, a threshold level in a reception sensitivity filter part to a level higher than a normal level, which is a reception strength when a direct wave is received. Thereby, the reception sensitivity of the GPS signals is reduced.

### CROSS REFERENCE TO RELATED APPLICATION

This application is related to and incorporates herein by reference Japanese Patent Application No. 2005-62800 filed on Mar. 7, 2005.

### FIELD OF THE INVENTION

The present invention relates to a position detecting system and method.

### BACKGROUND OF THE INVENTION

Conventionally, for example, in JP 2002-214321A and the like, GPS positioning systems have been proposed which suppress a reduction in position estimation accuracy. The GPS positioning systems estimate positions with a combination of GPS positioning, a dead-reckoning navigation for detecting positions by adding sensor outputs of a speed sensor, a gyro sensor and the like, or map matching by a map database. In this case, the systems retrieve information about multipath faults from a database of a server computer via a communication network to determine whether a current position has the possibility of suffering from the multipath faults. When the current position has that possibility, the systems increase an error estimation value of a GPS positioning solution so that it exceeds a predetermined error range. Thereby, the GPS positioning solution is not used, and a current position is estimated by using an estimation result by the dead-reckoning navigation.

However, a reflected wave of a GPS signal reflected by buildings and the like is longer in propagation path than a direct wave, so that the propagation time of radio waves becomes longer. A pseudo distance from a GPS satellite measured by use of the reflected wave is longer than a pseudo distance measured by use of the direct wave. As a result, a GPS positioning solution obtained from the reflected wave contains a large error.

On the other hand, an error estimation value to the GPS positioning solution is calculated based on satellite track information contained in a navigation message obtained by demodulating the GPS signal. The track information is the same as that obtained by receiving the direct wave. Accordingly, even when the reliability of the GPS positioning solution is reduced due to multipath, the error estimation value is not increased. As a result, conventional GPS positioning systems increase the error estimation value so as not to use GPS positioning solutions.

However, the conventional GPS positioning systems must perform positioning calculations (calculations of GPS positioning solution and error estimation value) by a GPS receiver for each reception of a GPS signal, and then increase an error estimation value of GPS positioning solutions.

### SUMMARY OF THE INVENTION

An object of the present invention is to provide a position detecting system that can suppress a reduction in position estimation accuracy without changing an error estimation value of a GPS positioning solution.

According to one aspect of the present invention, a position detecting system receives a GPS signal from a GPS satellite, and calculates a current position by positioning calculations, based on the GPS signal. Based on multipath information previously stored, it determines whether the calculated current position is in a region in which multipath is liable to occur. When the calculated current position is in a region in which multipath is liable to occur, it reduces the reception sensitivity of the GPS signal.

Preferably, the position detecting system determines whether the GPS signal exhibits reception strength of a predetermined threshold level or higher. When the GPS signal has reception strength of a predetermined threshold level or higher, it performs positioning calculations based on the GPS signal. When a current position is in a region in which multipath is liable to occur, it reduces the reception sensitivity of the GPS signal by changing the threshold level to a high level.

Although a reduction in GPS signal reception sensitivity will lower a GPS positioning rate and a time (Time to First Fix, hereinafter simply referred to as TTFF) until a first positioning result is outputted, a position detecting system using the GPS positioning and a dead-reckoning navigation in combination may have a low dependence on the GPS positioning. Therefore, a reduction in GPS reception sensitivity hardly affects position detection accuracy. Accordingly, to avoid performing positioning calculations based on a GPS signal affected by a multipath fault, when a current position is in a region in which multipath is liable to occur, the position detecting system reduces the reception sensitivity of the GPS signal by changing the threshold level to a high level. Thereby, in a region in which multipath is liable to occur, since positioning calculations based on a GPS signal with reception strength reduced due to multipath can be avoided, a reduction in position estimation accuracy can be suppressed without changing the error estimation value of the GPS positioning solution.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic diagram showing GPS satellites and a mobile body, in which a GPS receiver is mounted, according to one embodiment of the present invention;

FIG. 2 is a schematic diagram showing a direct wave and a reflected wave in the embodiment;

FIG. 3 is a block diagram showing a navigation system according to the embodiment;

FIG. 4 is a block diagram showing a GPS-CPU part according to the embodiment; and

FIG. 5 is a graph showing a relationship between an elevation angle of a GPS satellite and the threshold level of reception strength according to a variant of the embodiment.

### DETAILED DESCRIPTION OF THE EMBODIMENT

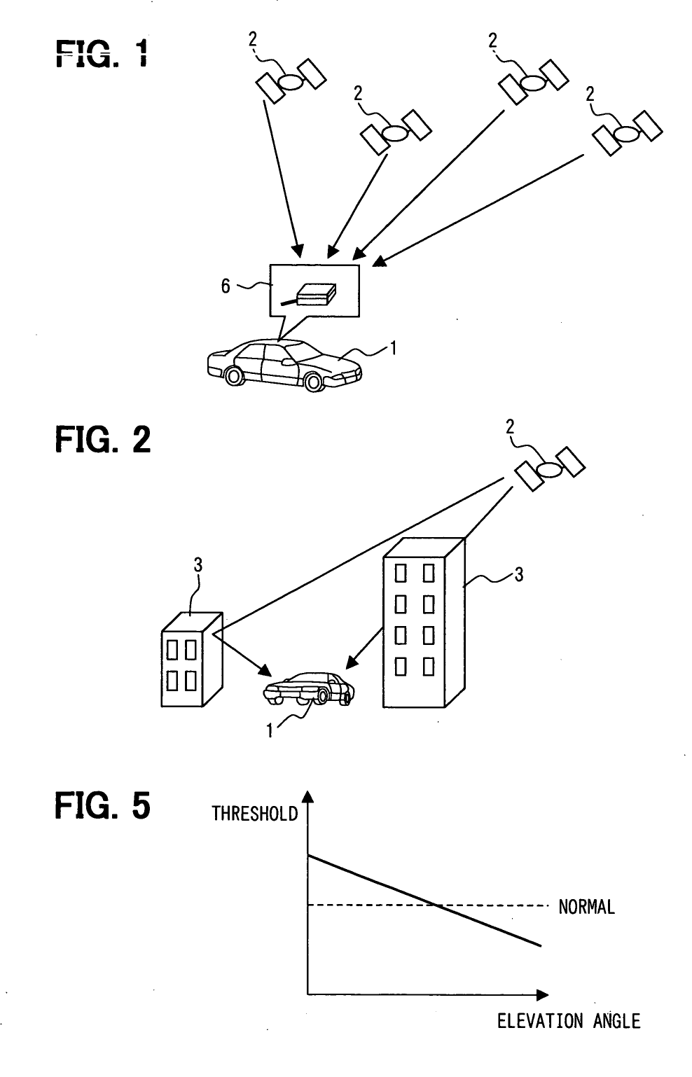

In this embodiment, a position detecting system is applied to a navigation system. The navigation system is mounted in a mobile body 1 such as a car as shown in FIG. 1. The navigation system includes a GPS receiver 6 that receives a GPS signal transmitted from GPS satellites 2. As shown in FIG. 2, the GPS signal received by the GPS receiver 6 contains a reflected wave influenced by a multipath fault such as a building 3. Therefore, the navigation system suppresses a reduction in position detection accuracy due to the reflected wave.

As shown in FIG. 3, the GPS receiver 6 comprises a GPS antenna 601, a GPS-RF part (circuit) 602, a GPS-BB part 603, and a GPS-CPU part 604. The GPS receiver 6 is connected to a navigation device 610. The navigation device 610 is connected to a memory 611, a gyro sensor 612, a slope sensor 613 and a speed sensor 614.

The plural GPS satellites 2, which are disposed over the Earth, periodically transmit navigation data necessary for positioning such as orbit information and time information of the satellites to the earth. The GPS antenna 601 catches a transmission signal transmitted from each GPS satellite 2 after being spread-spectrum-modulated by an encoded C/A code (Coarse Acquisition Code) assigned to the GPS satellite 2, and converts it into an electrical signal. The electrical signal is subjected to frequency conversion in the GPS-RF part 602. The GPS-BB part 603 converts the signal subjected to frequency conversion in the GPS-RF part 602 into a digital signal.

The GPS-CPU part 604 demodulates the navigation data of the GPS satellite 2 from the signal converted into the digital signal and measures the distance (pseudo distance) between the GPS satellite 2 and the GPS receiver 6 from a radio wave propagation time between the GPS satellite 2 and the GPS receiver 6.

The GPS-CPU part 604 calculates a position (latitude and longitude) of the GPS receiver 6 from the measured pseudo distance and detailed track data (ephemeris) of the GPS satellite 2 contained in the navigation data. The calculated position of the GPS receiver 6 is outputted to the navigation device 610 as positioning information.

The memory 611 is a storage medium that stores map data including road data, background data, character data, and is stored in a map data storing device not shown. The map data storing device provides various data according to requests from the navigation device 610. As a storage medium for storing these various data, although a CD-ROM or DVD-ROM is generally used in view of the amount of the map data, a recordable storage medium such as a memory card and a hard disk may be used.

Road data comprises link IDs with unique numbers assigned to different roads, link coordinate data, node coordinate data, road type data indicating road types such as expressways and national roads, and road width data. A link in the road data refers to the connection between two nodes on each road on a map, wherein each road on a map is split into plural parts by nodes such as intersections and branch points.

The link coordinate data contains the coordinates of the start point and the end point of the link. When a node is contained in the middle of a link, the coordinates of the node are contained in the node coordinate data. The road data is used not only to display a map but also to afford the shapes of roads during map matching processing and search for a guide route to a destination.

On the other hand, background data comprises polygons and other data constituting the background of a map. Polygon data is used to draw a two-dimension map flatly drawn.

The memory 611 is stored with multipath information about regions in which multipath is liable to occur. The multipath information comprises multipath polygon information indicating regions in which multipath is liable to occur, and information about reception strength (reception strength information) when a GPS signal affected by a multipath fault in the regions is received.

A GPS signal (reflected wave) affected by a multipath fault arrives later than a GPS signal (direct wave) not affected by a multipath fault, and the reflected wave becomes weaker in signal strength than the direct wave. As described above, as map data, multipath polygon information indicating regions in which multipath is liable to occur is associated with information about reception strength when reflected waves were received in the regions. Thereby, in the GPS-CPU part 604 described later, the reception sensitivity of GPS signals can be changed based on the information about reception strength contained in the map data. Regions in which multipath is liable to occur may be estimated from the shapes and sizes of buildings, and the like.

The gyro sensor 612 is a sensor that detects a travel azimuth of the mobile body 1, and the slope sensor 613 detects a slope angle due to the rolling, pitching, and yawing of the mobile body 1. The speed sensor 614 detects a travel velocity of the mobile body 1.

The navigation device 610 detects a current position with a combination of GPS positioning, dead-reckoning navigation, and map matching to enhance position detection accuracy. The GPS positioning calculates the current position (latitude and longitude) of the mobile body 1 by the GPS receiver 6. The dead-reckoning navigation calculates a current position of the mobile body 1 by adding a travel distance from the vehicle speed sensor 614 according to an azimuth calculated from the gyro sensor 612.

The navigation device 610 calculates a current position by the dead-reckoning navigation, and at the same time corrects the current position, based on a latitude and longitude by the GPS positioning, thereby eliminating the influence of a sensor error in the dead-reckoning navigation (hybrid navigation). Furthermore, to calculate a more accurate current position, by comparing the current position and travel track of the mobile body 1 calculated by the hybrid navigation with the road data constituting the map data, the navigation device 610 estimates the road on which mobile body 1 is running (map matching). A current position of the mobile body 1 is obtained with high accuracy by the map matching.

On determining that the current position of the mobile body 1 is in a region in which multipath is liable to occur, from the above multipath information, the navigation device 610 outputs reception strength information associated with multipath polygon information indicating the position of the region to the GPS-CPU part 604.

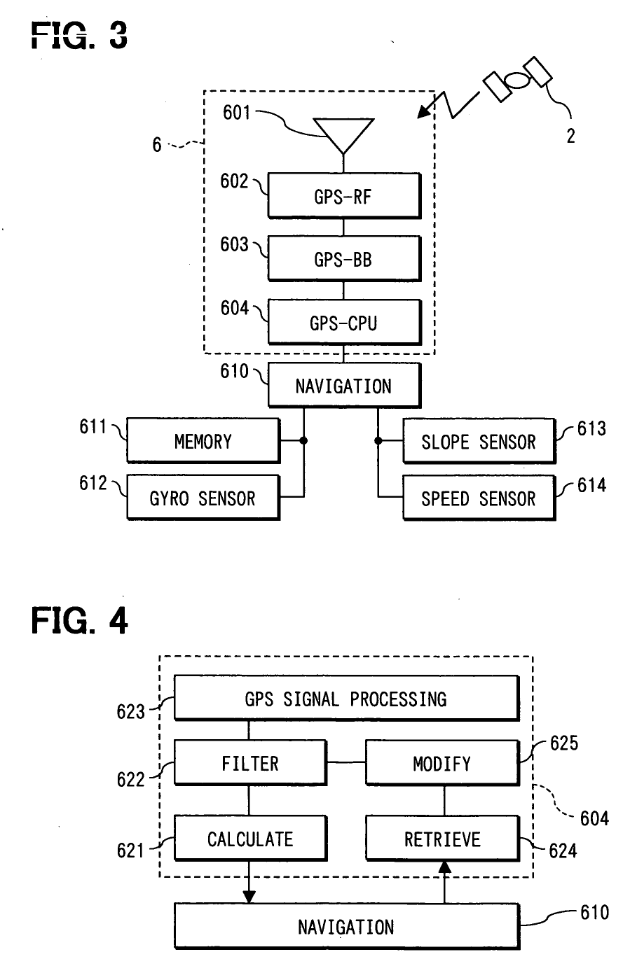

As shown in FIG. 4, the GPS-CPU part 604 includes the respective functions of a positioning calculation part 621, a reception sensitivity filter part 622, a GPS signal processing part 623, a navigation information acquiring part 624, and a reception sensitivity modification part 625.

The GPS signal processing part 623 demodulates the navigation data of the GPS satellite 2 from a digital signal converted by the GPS-BB part 603, and measures the distance (pseudo distance) between the GPS satellite 2 and the GPS receiver 6 from a radio wave propagation time between the GPS satellite 2 and the GPS receiver 6. Moreover, the GPS signal processing part 623 calculates the reception strength of GPS signals of each of the GPS satellites 2.

The reception sensitivity filter part 622 determines whether a reception strength calculated by the GPS signal processing part 623 is equal to or greater than a threshold level modified by the reception sensitivity modification part 625, and on determining that it is equal to or greater than a threshold level, sends a pseudo distance and navigation data measured based on the GPS signal to the positioning operation unit 621.

The positioning operation unit 621 calculates the position (latitude and longitude) of the GPS receiver 6 from the pseudo distance sent from the reception sensitivity filter part 622 and the detailed track data of the GPS satellite 2 contained in the navigation data (ephemeris). The calculated position of the GPS receiver 6 is outputted to the navigation device 610 as positioning information.

When the current position of the mobile body is in a region in which multipath is liable to occur, the navigation information retrieving part 624 retrieves reception strength information outputted from the navigation device 610. The reception sensitivity modification part 625 modifies a threshold level in the reception sensitivity filter part 622 to a level higher than a normal level (reception strength when a direct wave is received), based on the reception strength information retrieved by the navigation information retrieving part 624, thereby reducing the reception sensitivity of the GPS signal. By thus changing the threshold level to a high level, the reception sensitivity of the GPS signal can be reduced.

Although a reduction in GPS reception sensitivity will worsen a GPS positioning rate and a time until a first positioning result is outputted (Time to First Fix, hereinafter referred to as TTFF), since present dead-reckoning navigation greatly enhances estimation accuracy, a device using the GPS positioning and the dead-reckoning navigation in combination may have a low dependence on the GPS positioning. Therefore, a reduction in GPS reception sensitivity hardly affects position detection accuracy.

Therefore, in a region susceptible to multipath faults, the GPS-CPU part 604 changes a threshold level in the reception sensitivity filter part 622 to a high level to avoid positioning operations based on a GPS signal with reception strength reduced due to a multipath fault.

With this, in a region in which multipath is liable to occur, since positioning operations based on a GPS signal with reception strength reduced due to multipath can be avoided, unlike conventional systems, a reduction in position estimation accuracy can be suppressed without changing an error estimation value of a GPS positioning solution.

The reception sensitivity modification part 625 of this embodiment modifies a threshold level in the reception sensitivity filter part 622 from the reception strength information associated with the multipath polygon information. Furthermore, the threshold level may be changed according to the elevation angle of the GPS satellite 2 calculated from the detailed track data of the GPS satellite 2.

Generally, when an elevation angle of the GPS satellite 2, that is, the angle of a line connecting the GPS satellite 2 and the GPS receiver 6 formed with respect to the horizontal surface on the ground is smaller, GPS signals from the GPS satellite 2 are more liable to suffer from multipath faults. On the other hand, when an elevation angle of the GPS satellite 2 is larger, GPS signals from the GPS satellite 2 are less liable to suffer from multipath faults.

Accordingly, as shown in FIG. 5, the reception sensitivity modification part 625 may modify a threshold level to a higher level when an elevation angle of the GPS satellite 2 is smaller. When an elevation angle of the GPS satellite 2 is larger, it may change a threshold level to a lower level. Thereby, not only can reception sensitivity be changed based on the above multipath information, reception sensitivity can be changed according to an elevation angle of the GPS satellite 2.

What is claimed is:

1. A position detecting system that detects a current position with a combination of GPS positioning and dead-reckoning navigation, the device comprising:
a GPS receiving means that receives a GPS signal from a GPS satellite;
a reception strength determining means that determines whether the received GPS signal of the GPS receiving means has a reception strength higher than a predetermined threshold level;
a positioning calculation means that, when it is determined by the determining means that the GPS signal has a reception strength higher than the predetermined threshold level, performs a positioning calculation based on the GPS signal;
a multipath information storing means that stores multipath information about a region in which a multipath is liable to occur; and
a reception sensitivity change means that, when a current position detected by at least one of the GPS positioning and the dead-reckoning navigation is in the region in which the multipath is liable to occur, changes the predetermined threshold level to a higher level to reduce the reception sensitivity of the GPS signal.

2. The position detecting system according to claim 1,
wherein the multipath information storing means includes, as the multipath information, multipath polygon information indicating a position of the region in which the multipath is liable to occur, and information about the reception strength of the GPS signal affected by a multipath fault in the region, and
wherein the reception sensitivity change means changes the predetermined threshold level based on the information about the reception strength.

3. The position detecting system according to claim 1,
wherein the reception sensitivity change means changes the predetermined threshold level to a higher level as an elevation angle of the GPS satellite is smaller, and changes the predetermined threshold level to a lower level as an elevation angle of the GPS satellite is larger.

4. The position detecting system according to claim 1,
wherein the positioning calculation means detects the current position with a combination of GPS positioning, dead-reckoning navigation and map matching.

5. A method of detecting a current position of a mobile body, comprising:
receiving a GPS signal from a GPS satellite;
calculating a current position by positioning calculations based on the GPS signal;
determining whether the calculated current position is in a region, in which a multipath is liable to occur, based on multipath information stored in advance; and
reducing a reception strength of the GPS signal when the calculated current position is in the region in which the multipath is liable to occur.

6. The position detecting method according to claim 5,
wherein the reception sensitivity is set lower when an elevation angle of the GPS satellite is smaller.
